(19) United States
(12) Patent Application Publication
(10) Pub. No.: US 2008/0228576 A1
(43) Pub. Date: Sep. 18, 2008

(54) AD PERFORMANCE OPTIMIZATION FOR RICH MEDIA CONTENT

(75) Inventor: Tadashi Yonezaki, Newton, MA (US)

Correspondence Address: Trellis Intellectual Property Law Group, PC, 1900 EMBARCADERO ROAD, SUITE 109, PALO ALTO, CA, 94303, US

(73) Assignee: SCANSCOUT, INC., Cambridge, MA (US)

(21) Appl. No.: 11/943,357

(22) Filed: Nov. 20, 2007

Related U.S. Application Data
(60) Provisional application No. 60/906,713, filed on Mar. 13, 2007.

(51) Int. Cl. G06Q 30/00

(52) U.S. Cl. 705/14

(57) ABSTRACT

In one embodiment, a method for optimizing advertisement performance is provided. In one embodiment, advertisements may be clustered together into different buckets of advertisements. Rich media content may also be clustered together. A performance model may then be generated that is based on previous performance of ads with content. The performance data may be used to predict which ads may provide the best performance when shown with a target piece of content that is going to be displayed. Particular embodiments use performance data for advertisements in an ad bucket to determine which ad bucket out of multiple ad buckets may provide the best performance for a content bucket that includes the target content. The ad bucket includes a plurality of ads and the method determines which ad should be displayed with the target content. In one embodiment, performance data is used to determine which ad to display.

### CROSS REFERENCES TO RELATED APPLICATIONS

This application claims priority from U.S. Provisional Patent Application Ser. No. 60/906,713, entitled “Method for Optimizing Ad Performance of Rich Media Content”, filed on Mar. 13, 2007, which is hereby incorporated by reference as if set forth in full in this application for all purposes.

### BACKGROUND

Particular embodiments generally relate to ad optimization.

When viewing web pages or performing searches, ads are often placed in the pages being viewed. The ads are typically determined based on the content of the web page, which includes mostly static content, such as textual content. The ads to display with the page are then determined based on the static content, such as by matching words in the content to ads.

With the advent of video, different features may be provided in the video. For example, video may include audio, moving objects, etc. Accordingly, it may be more difficult to determine which ads to display with video content.

### SUMMARY

In one embodiment, a method for optimizing advertisement performance is provided. In one embodiment, advertisements may be clustered together into different buckets of advertisements. The advertisements may be clustered based on classifiers for features of the advertisements. For example, if advertisements are related in concept, such as the advertisements may include sports figures, they may be clustered together in a bucket. Rich media content may also be clustered together. For example, classifiers may be used to cluster the content together based on features of the content.

A performance model may then be generated that is based on previous performance of ads with content. The performance data may be used to predict which ads may provide the best performance when shown with a target piece of content that is going to be displayed. Particular embodiments use performance data for advertisements in an ad bucket to determine which ad bucket out of multiple ad buckets may provide the best performance for a content bucket that includes the target content. The performance data may be a model based on how ads previously performed with content in the bucket of content. Features for both the content bucket and the ad buckets are analyzed to determine one or more ad buckets that may provide the highest probability of optimal ad performance. For discussion purposes, a single bucket of advertisements may be determined, which is considered to include ads that collectively provide the highest probability of optimal performance if an ad in the bucket is rendered with the target content.

The ad bucket includes a plurality of ads and the method determines which ad should be displayed with the target content. In one embodiment, performance data is used to determine which ad to display. For example, features for ads in the ad bucket and features for the target content are used to determine which ad in the ad bucket of ads may provide the best performance if rendered with the target content. In this case, an advertisement that performed well with similar content to the target content in the past may be selected using the performance data. For example, performance data showing how the ads performed with similar content in the content bucket may be used to determine which ad provides the highest probability that it will perform well with the target content.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example system for providing advertisements for optimal performance according to one embodiment.

FIG. 2 depicts a more detailed example of an ad server according to one embodiment.

FIG. 3 shows a flow chart of a method for determining an ad for target content according to one embodiment.

FIG. 4 depicts a simplified flow chart for training a performance model according to one embodiment.

### DETAILED DESCRIPTION OF EMBODIMENTS

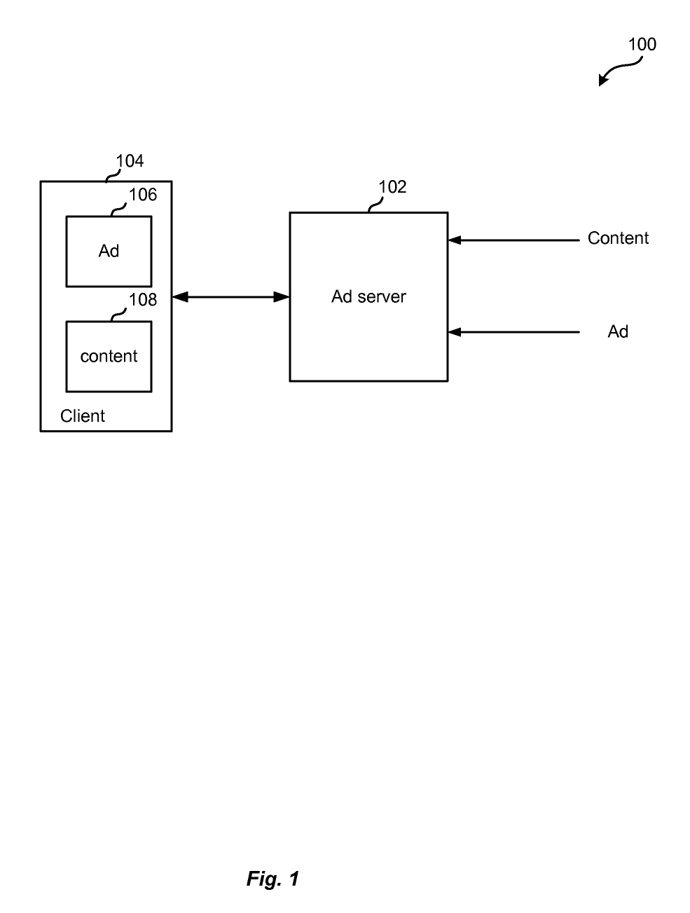

FIG. 1 depicts an example system 100 for providing advertisements for optimal performance according to one embodiment. As shown, system 100 includes an ad server 102 and a client 104. Although one ad server 102 and one client 104 are shown, it will be understood that multiple instances may be provided in system 100.

Ad server 102 is configured to serve advertisements to client 104. An advertisement may include any content. For example, advertisements may include information about the advertiser, such as the advertiser's products, services, etc. Advertisements may include elements possessing text, graphics, audio, video, animation, special effects, user interactivity features, uniform resource locators (URLs), presentations, targeted content categories, etc. In some applications, audio-only or image-only advertisements may be used. Advertisements may include non-paid recommendations to other links/content within a website or to other websites. The advertisement may also be data from a publisher or data from a servicer of ad server 102, or other third-party data sources. The advertisement may also include coupons, maps, ticket purchase information, or any other information. When advertisements are described, they may be full length advertisements, portions of advertisements (e.g., units of an advertisement), etc.

Client 104 may be any computing device that can display advertisements and content. For example, client 104 includes a computer, laptop computer, personal digital assistant (PDA), cellular phone, set top box, television, digital music player, smart phone, etc. Client 104 may include a display and speaker that may be used to render content and/or advertisements.

Client 104 may include an ad display area 106 and a content display area 108. Ad display area 106 is configured to display ads received from ad server 102. Content display area 108 is configured to display content received from ad server 102. Also, the content may be received from devices other than ad server 102. In one embodiment, the content may be rich media content, which may be rendered in content display area 108. Examples of rich media content include content that possesses elements of audio, video, animation, special effects, user interactivity features, etc. For example, rich media content may include a streaming video, a stock ticker that continually updates, a pre-recorded webcast, a movie, flash trademark symbol animation, slideshow, or another presentation. The rich media content may be provided through a web page or through other methods, such as streaming video, streaming audio, podcasts, etc. Rich media content may be digital media that is dynamic, which may be different from non-rich media content, which may include standard images, text links, and search engine advertising. The non-rich media may be static over time while rich media content may change over time.

As content is rendered in content displayer area 108, advertisements may be rendered in ad display area 106. Particular embodiments determine advertisements that should be rendered in ad display area 106 as content is being rendered in content display area 108. Ad server 102 is configured to select ads to render with content that may optimize the performance of the ad. The performance may be measured based on any number of factors. For example, performance may be the number of times an advertisement is selected, the click-thru rate, etc.

To determine an ad to render with the target content, advertisements and content may be classified into buckets. A content bucket may include a plurality of pieces of content and an ad bucket may include a plurality of advertisements. When content in a content bucket is going to be displayed (referred to as target content), ad server 102 is configured to determine an ad bucket for the content bucket. In one embodiment, the ad bucket is determined based on how ads in the ad bucket previously performed with respect to content in the content bucket containing the target content. In one embodiment, performance data is determined and an ad bucket that provides the highest probability of providing the optimal performance if ads from the bucket are rendered with content in the content bucket is selected.

The ad bucket may include many ads and thus an ad in the ad bucket needs to be determined. Performance data for the ads is then used to determine which ad in the ad bucket to display with the target content. The performance data may include information on how ads have performed with content in the content bucket. In one example, the performance data includes weightings for features for the ads. The features for an ad that best matches the features for the target content is then determined. Once an ad is selected, it is sent to client server 104 for rendering in ad display area 106 at a time when content is displayed in content display area 108. Because content is dynamic, multiple ads may be determined for various times in the content. Thus, as content is rendered, different ads may be displayed in ad display area 106.

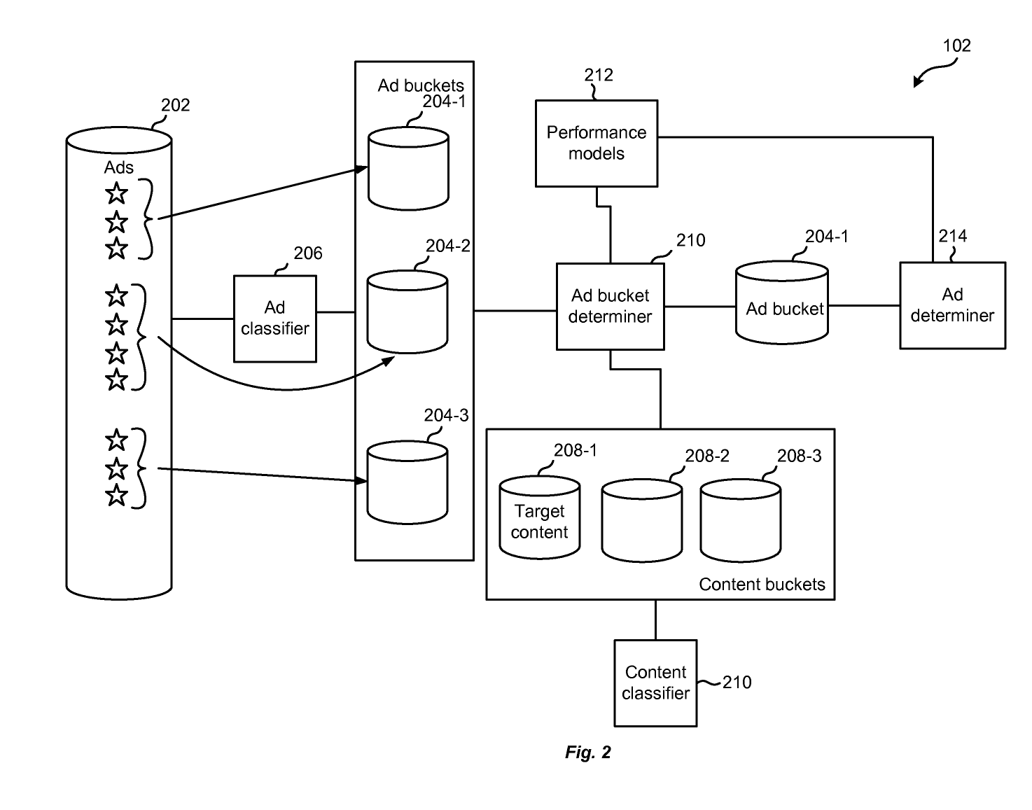

FIG. 2 depicts a more detailed example of ad server 102 according to one embodiment. A plurality of advertisements may be stored in storage 202. The advertisements may be uploaded to storage 202 from advertisers or any other entity.

An ad classifier 206 may then classify the advertisements into ad buckets 204. For example, a first set of ads may be classified to ad bucket 204-1, a second set of ads may be classified into an ad bucket 204-2, and a third set of ads may be classified into an ad bucket 204-3. It will be understood that a single ad may be found in multiple ad buckets 204 or just a single ad bucket 204.

Ad classifier 206 may classify the advertisements based on characteristics of the ads. For example, a classifier model may be used to classify advertisements in the buckets 204. The classifier model may map advertisements in a specific ad campaign to ad buckets 204. For example, ads that are directed to specific campaigns, such as a sports ad campaign for sports drinks may be mapped to the same ad bucket 204. Also, other information may be used, such as keywords of ads as a refiner technique. For example, ads that include similar keywords may be classified into the same ad bucket 204. For example, if ads included the same keywords of sports drink, they may be classified into the same ad bucket 204.

Content may also be classified into content buckets 208 based on characteristics of the content. The content buckets may include content that is determined to be similar. For example, content with the same concept of sports may be grouped in a content bucket 208. In one embodiment, a content classifier 210 extracts features for content and classifies the content based on its features. The features may include a term vector, a concept vector, video features (such as a color histogram, shot break frequency, objects in the content), audio features (e.g., spectrogram, tempo, beat, etc.), metadata (e.g., title, tag, description, link), etc. Although these features are provided, it will be understood that other features may be appreciated.

A term vector may be text and metadata. A term vector may turn into a concept vector, which may be a vector that is reduced from the term space. The concept vector may be thought of as a vector that encompasses a concept, such as the concept of sports, health, etc. The shot break frequency may be where a shot breaks, such as when a scene ends or breaks in the content.

Content classifier 210 is configured to use these features to group similar content together. For example, weights may be assigned to features for content. Content that includes similar weightings for features may be grouped together in content buckets 208. For example, content based on a similar concept may be grouped together.

Once advertisements are classified into ad buckets 204 and content is classified into content buckets 208, an ad bucket determiner 210 is configured to determine an ad bucket 204. For example, when target content will be displayed on content display area 108, an ad needs to be determined that will be displayed with the target content. The determined ad bucket 204 is then used to determine an ad that will be displayed with the target content.

A performance model 212 may be used to determine an ad bucket 204. Although only one ad bucket 204 is described, it will be understood that “N” ad buckets 204 may be determined. Further, an ad bucket 204 may be determined for a certain time in the target content. It will be understood that at various times in the target content, different ad buckets 204 may be determined. For example, during a sports scene in the content, an ad bucket 204 classified by the concept vector of sports may be determined.

Performance model 212 may be a classifier that is used to determine which ad bucket 204 should be selected. Performance model 212 may be trained on data based on past performance of advertisements in ad buckets 204. The training will be described in more detail below.

In one embodiment, each ad bucket 204 includes a performance model 212 that has been trained using performance data for ads in each ad bucket 204. Whichever ad bucket 204 that includes performance data that indicates ads in its bucket performed the best based on previous performance data is then selected. Thus, the ad bucket determined includes advertisements that have worked well previously with content in content bucket 208.

Performance model 212 may include features for ads that are weighted based on the performance data. The features may be any information, such as textual, oral, and/or visual signals. The features may be associated with probabilities. The probabilities indicate levels of strength for the features (e.g., weightings). For example, the probability may be higher for a feature if it is determined that the feature is responsible for the ad performing well in the past. For example, if an ad is displayed with content and a high click-thru rate is seen, then the features may be rated with a high probability. Also, the features do not have to come from the content. For example, features may be from user information, such as a user profile. Thus, if the ad is not receiving clicks, then the user profile may be used as one of the features. Thus, the probability for this feature, such as a behavioral feature, may be adjusted.

In one embodiment, when the advertisements are displayed with content, performance data for the advertisement and other advertisements in ad bucket 204 may be determined and used to train a performance model 212 for ad bucket 204. In one example, when an advertisement is displayed with content during a certain period, the weightings (e.g., probability) of undisplayed advertisements remain unchanged. However, the weightings for the displayed advertisement may change. For example, the weightings may be increased if favorable performance data is determined for the advertisement or decreased if unfavorable performance data is received.

In another embodiment, the performance model 212 may be determined based on a fallback process (e.g., a conceptual match) because not enough statistics are available. If an advertisement is first displayed and receives favorable performance data, then the system may continue to select that advertisement, which does not allow other advertisements to be displayed. To compensate for this problem, one particular embodiment may take unclicked impressions for advertisements as clicks for other advertisements. For example, if an advertisement is displayed with content and does not receive a click (i.e., it receives negative performance data), then the probability for other advertisements in ad bucket 204 may be increased. Thus, the performance data for other advertisements increases probability for an ad because of unfavorable results for other advertisements.

In one example, assuming there are 5 IDs, id=0, . . . , 4 in ad bucket 204, and only ID0 receives 6 clicks for 10 impressions. Impressions may be instances when ads are rendered with content. This yields a probably of 0.6 for ad ID0 and there are no statistics for other IDs. In this case, the other IDs could get clicks because of the 4 unclicked impression on ID0, therefore count 1 click for each IDs ({Pᵢ=(4_{unclick}/4_{IDs})/10ᵢₘₚᵣₑₛₛᵢₒₙₛ=0.1|i=1, . . . , 4}). Thus, the probability is increased 0.1 for each ad ID1, ID2, ID3, and ID4.

In this example, it implicitly assumes a user always clicks if right advertisement is placed. However, this may not happen during use. Therefore, average click through rate may be taken into account, i.e. distribute only subtraction of clicked count from expected click.

In the above example, if average click through rate is 0.5, no action is required, because ID0, achieves click through rate=0.6, performs better than the average; (Pᵢ=0 i=1, . . . , 4). If average click through rate is 0.8, 2 unclicked impressions are distributed evenly to other ad IDs; (({Pᵢ=(2_{unclick}/4_{IDs})/10ᵢₘₚᵣₑₛₛᵢₒₙₛ=0.05|i=1, . . . , 4})). Thus, the probability is increased 0.05 for each ad ID1, ID2, ID3, and ID4.

In one embodiment, the target content is included in a content bucket 208-1. The features of content bucket 208-1 are then input into performance model 212 for an ad bucket 204, which outputs a probability for the ad bucket. The probabilities for all ad buckets 204 may be determined and the ad bucket that includes the highest probability may be selected. The probability may be an indication that the selected ad bucket offers the highest probability that its ads may perform the best if displayed with content in content bucket 208-1.

Once the selected ad bucket 204 is determined, an ad determiner 214 selects an advertisement in ad bucket 204 for display with the target content. Performance data in performance model 212 may also be used to determine the ad. Ads are classified based on features for each ad. The features may be weighted according to the performance data. The distance from the features for each ad as compared to features for the target content may then be computed. In one example, advertisements in ad bucket 204 are sorted and ranked based on the distance of the features. The advertisement that has weightings of features that most closely match the features of the target content may then be selected as the ad to display with the content.

In another example, if “N” ad buckets 204 are determined, the ads in “N” buckets may be sorted together. The distances from features for all the ads as compared to features for the target content may be computed and the all the ads are sorted together. The advertisement that has weightings of features that most closely match the features of the target content may then be selected as the ad to display with the content. The ad may then be sent to client 104 for rendering with the target content.

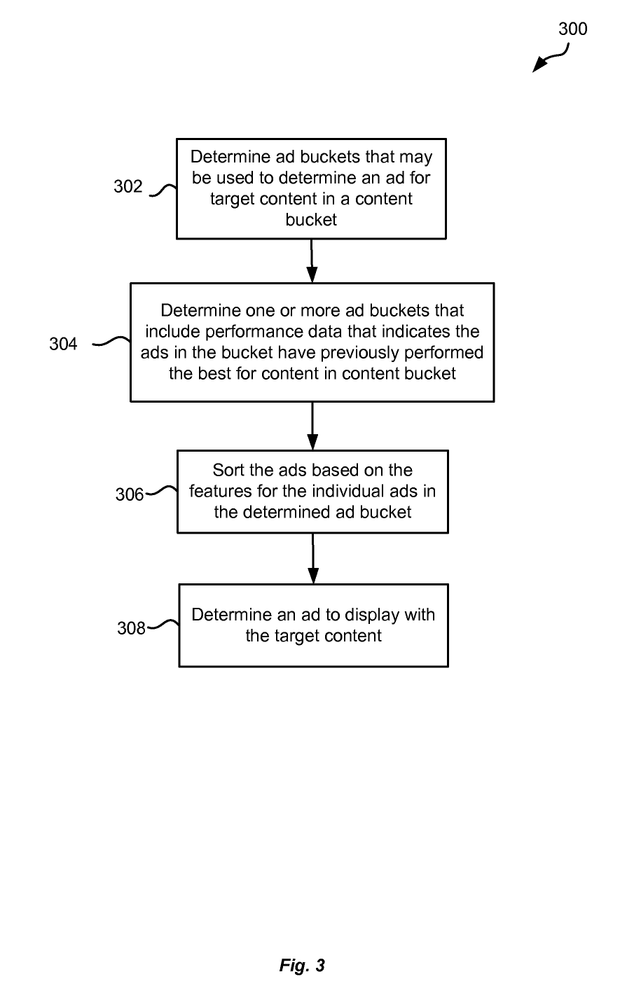

FIG. 3 shows a flow chart 300 of a method for determining an ad for target content according to one embodiment. Step 302 determines ad buckets 204 that may be used to determine an ad for target content in a content bucket 208. For example, any number of ad buckets 204 may be determined. Ad buckets 204 may be classified based on features for the ads. For example, there may be a number of ad buckets for a news category, a number of ad buckets for a sports category, etc. In one example, a system may include a large number of ad buckets. Thus, a system may not want to analyze all the ad buckets. Step 302 may then determine a subset of all ad buckets for the performance analysis. For example, ad buckets may be determined based on target content that is being shown. For example, if the target content is considered to be sports content, then ad buckets 204 that are classified in the sports category may be determined. However, it will be understood that all ad buckets 204 may be considered.

Step 304 determines one or more ad buckets 204 that includes performance data that indicates the ads in the bucket have previously performed well for content in content bucket 208. Thus, the performance of similar ads to similar content for the target content is analyzed to determine which ad bucket 204 should be used. As discussed above, features for content in content bucket 208 may be input into performance models 212 and ad buckets 204 that yield the highest probability of providing optimal performance are determined.

Step 306 sorts the ads based on the features for the individual ads in the determined ad bucket 204. For example, the distances in features for ads from the target content's features is determined and used to sort the ads.

Step 308 then determines an ad to display with the target content. The ad that includes features that match the features of the target content the best may be determined. The ad may then be displayed with the target content at a certain time.

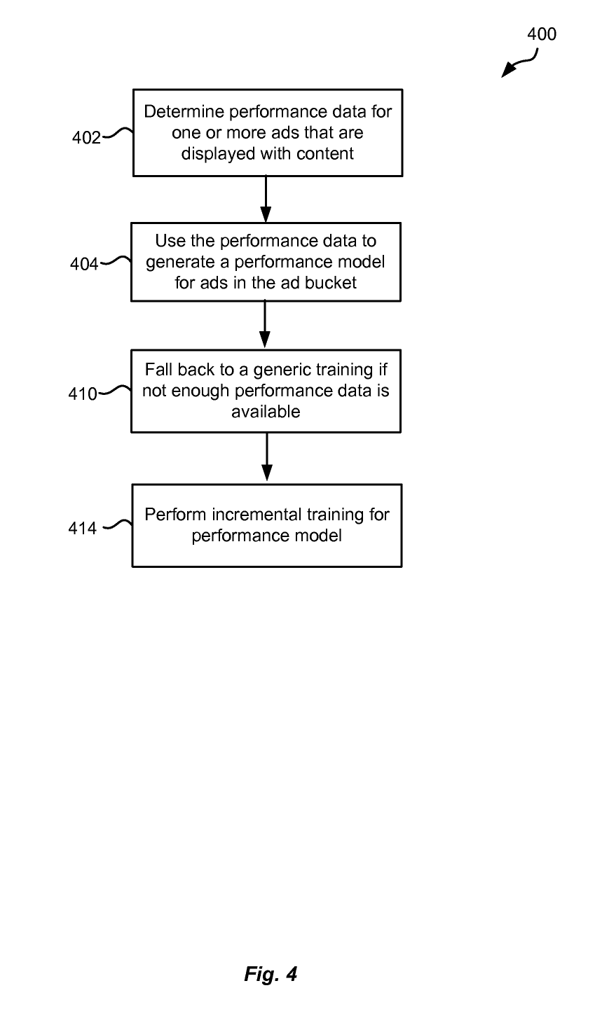

A performance model 212 may be trained based on performance data. FIG. 4 depicts a simplified flow chart 400 for training performance model 212 according to one embodiment. Step 402 determines performance data for one or more ads that are displayed with content. The performance data may include performance data relating to how an ad performed with content, such as the click-thru rate, or any other metric that may be used to gauge performance. Also, the ad's performance may be determined based the performance of other ads. For example, when an ad is displayed with content and clicks are not received for this ad, then it may be determined that other ads may be more positively viewed if displayed with this content.

Step 404 uses the performance data to generate a performance model, which is used to select an ad bucket from ad buckets 204. For example, a performance model is trained so that an ad bucket is more likely to be selected for a content bucket based on the performance data. Different embodiments may be used to determine performance model 212. For example, a classification method, such as a logit-boosting model can be used. The model may be trained based on a target probability distribution and not input-class pairs. Input-class pairs may be content/ad pairs where ads are considered as a ‘class’ for contents and displayed with content. Using the distribution, the model is trained based on the distribution of probability for all ad bucket 204. The model may be trained less sensitive to features, which are less correlated to performance.

In another embodiment, a stored probability matrix (content ID vs. number ID) may be used. For example, collected data is shown in Table I.

TABLE I

| content | ad | action |
|---|---|---|
| 1 | a | clicked |
| 1 | b | non-clicked |
| 1 | a | non-clicked |
| 1 | b | clicked |
| 1 | a | clicked |

The data in table I shows content/ad pairs and an action that occurred when the ad was rendered with the content. For example, the ad may or may not have been clicked. The data in table I is then fed into a model trainer. The model is then trained based on the actions taken for the content-ad pair. For example, table II shows the distribution of clicked probability for the content/ad pairs.

TABLE II

| content | ad | probability |
|---|---|---|
| 1 | a | ⅔ |
| 1 | b | ½ |

The probability for the content/ad pairs are then used to train performance model 212.

As additional data is received, step 408 may perform incremental training for performance model 212. Different embodiments may be used to incrementally train the model. In a first embodiment, the inputs that were used to train the model may be updated with the new performance data. In this case, a new model is built with the updated performance data combined with the old performance data. For example, a probability may be updated and a new model is generated as shown in equation 1.1.

$${P}_{( {c}_{id} , {d}_{id} )} = w \cdot {P}_{( {c}_{id} , {d}_{id} )}^{new} + ( 1 - w ) \cdot {P}_{( {c}_{id} , {d}_{id} )} \qquad ( 1.1 )$$

where P_{c}_{_{id}}_{,d}_{_{id}} is the updated probability of d_{id} gets clicks at c_{id}, w(0≦w≦1) is weight, P^{new} is the new probability computed from the current statistics. Then, new model is built on P_{c}_{_{id}}_{,d}_{_{id}}.

In one example, the performance data history and an updated probability distribution by weighted sum of stored statistics is determined. An auto-regressive (AR) scheme or moving average may be used to update the probability distribution.

In a second embodiment, a new model may be trained with the new performance data. The new model is then combined with the old model to determine the incrementally updated model. For example, a new model is built from scratch with new statistics and combined with the previous model as shown in equation 1.2.

$$NewModel = {\sum }_{t = 0}^{T} {w}_{t} {M}^{t} \\ {M}^{t} = {\sum }_{i = 0}^{{N}^{t}} {w}_{i}^{t} \cdot {C}_{i}^{t} ( t = 1 , … , T ) \\ {M}^{0} = {\sum }_{i = 0}^{{N}^{0}} {w}_{i}^{0} \cdot {C}_{i}^{0} \qquad Equation 1.2$$

where M^{t} is model trained at t times before, w is weight for each model/class (Σw=1), C is weak classifiers.

In a third embodiment, a new model may be trained as a combined model of additional model to the existing model. An additional model is trained with new performance data, so that it compensates errors cased by the existing model.

Although the description has been described with respect to particular embodiments thereof, these particular embodiments are merely illustrative, and not restrictive. Although advertisements are described, it will be understood that advertisements may referred to any information that can be rendered with rich media content.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for optimizing performance of advertisements, the method comprising:
determining a content bucket for target rich media content, the content bucket including a plurality of rich media content pieces;
determining an ad bucket in a plurality of ad buckets based on performance data for ads in the ad bucket as applied to features for the content bucket, the ad bucket including a plurality of advertisements; and
determining an advertisement in the plurality of advertisements in the ad bucket to render with the target rich media content based on the performance data for the plurality of advertisements.

2. The method of claim 1, wherein the performance data includes data on how advertisements in the plurality of advertisements performed with respect to the plurality of rich media content pieces in the content bucket.

3. The method of claim 1, wherein the performance data includes a probability determined based on the previous performance of an ad with a rich media content piece in the plurality of rich media content pieces.

4. The method of claim 3, wherein the previous performance of the ad for the rich media content affects the probability of another ad.

5. The method of claim 1, wherein determining the ad bucket comprises:
determining a performance model for the ad bucket using the performance data;
determining features for the content bucket; and
determining a probability for the ad bucket based on the features and the performance model.

6. The method of claim 5, further comprising:
determining the probabilities for the plurality of ad buckets; and
determining the ad bucket based on the determined probabilities.

7. The method of claim 6, further comprising determining the ad bucket that provides a highest probability for optimal performance if rendered with the target content.

8. The method of claim 1, wherein determining the advertisement comprises:
determining a distance from features in the plurality of advertisements to features in the target content; and
determining the advertisement based on its having a smallest determined distance as compared to other advertisements in the plurality of advertisements.

9. The method of claim 1, further comprising sending the advertisement to a client for rendering with the target content.

10. An apparatus configured to optimize performance of advertisements comprising:
one or more processors; and
logic encoded in one or more tangible media for execution by the one or more processors and when executed operable to:
determine a content bucket for target rich media content, the content bucket including a plurality of rich media content pieces;
determine an ad bucket in a plurality of ad buckets based on performance data for ads in the ad bucket as applied to features for the content bucket, the ad bucket including a plurality of advertisements; and
determine an advertisement in the plurality of advertisements in the ad bucket to render with the target rich media content based on the performance data for the plurality of advertisements.

11. The apparatus of claim 10, wherein the performance data includes data on how advertisements in the plurality of advertisements performed with respect to the plurality of rich media content pieces in the content bucket.

12. The apparatus of claim 10, wherein the performance data includes a probability determined based on the previous performance of an ad with a rich media content piece in the plurality of rich media content pieces.

13. The apparatus of claim 12, wherein the previous performance of the ad for the rich media content affects the probability of another ad.

14. The apparatus of claim 10, wherein the logic when executed is further operable to:
determine a performance model for the ad bucket using the performance data;
determine features for the content bucket; and
determine a probability for the ad bucket based on the features and the performance model.

15. The apparatus of claim 14, wherein the logic when executed is further operable to:
determine the probabilities for the plurality of ad buckets; and
determine the ad bucket based on the determined probabilities.

16. The apparatus of claim 15, wherein the logic when executed is further operable to determine the ad bucket that provides a highest probability for optimal performance if rendered with the target content.

17. The apparatus of claim 10, wherein the logic when executed is further operable to:
determine a distance from features in the plurality of advertisements to features in the target content; and
determine the advertisement based on its having a smallest determined distance as compared to other advertisements in the plurality of advertisements.

18. The apparatus of claim 10, wherein the logic when executed is further operable to send the advertisement to a client for rendering with the target content.

19. An apparatus configured to optimize performance of advertisements, the method comprising:
means for determining a content bucket for target rich media content, the content bucket including a plurality of rich media content pieces;
means for determining an ad bucket in a plurality of ad buckets based on performance data for ads in the ad bucket as applied to features for the content bucket, the ad bucket including a plurality of advertisements; and
means for determining an advertisement in the plurality of advertisements in the ad bucket to render with the target rich media content based on the performance data for the plurality of advertisements.

20. The apparatus of claim 19, wherein the performance data includes data on how advertisements in the plurality of advertisements performed with respect to the plurality of rich media content pieces in the content bucket.
